(19) United States
(12) Patent Application Publication
(10) Pub. No.: US 2008/0199680 A1
(43) Pub. Date: Aug. 21, 2008

(54) Method Of Applying A Layer To A Surface, As Well As An Assembly And A Decorative Panel

(76) Inventors: Wilhelmus Josephus Alex Van De Wall, Heeze (NL); Hendrikus Hubertus Gerardus Voncken, Elsloo (NL)

Correspondence Address: ROBERTS & ROBERTS, LLP;ATTORNEYS AT LAW, P.O. BOX 484, PRINCETON, NJ, 08542-0484, US

(21) Appl. No.: 11/917,549

(22) PCT Filed: Jun. 16, 2006
(86) PCT No.: PCT/NL06/00297

§ 371 Date: Mar. 10, 2008

(30) Foreign Application Priority Data
Jun. 17, 2005 (NL) 1029274

(51) Int. Cl. B32B 5/18; B32B 23/06; C08F 2/48

(52) U.S. Cl. 428/308.8; 428/336; 428/332; 428/306.6; 427/508

(57) ABSTRACT

The present invention relates to a method for applying a layer to a surface. The present invention furthermore relates to an assembly consisting of a layer applied to a surface, and to a decorative panel built up of a core and a decorative layer on one or on both sides of the core. The object of the present invention is to apply a thin layer to a surface whilst effecting a good bond of the thin layer to the surface.

The present invention relates to a method for applying a layer to a surface. The present invention furthermore relates to an assembly consisting of a layer applied to a surface, and to a decorative panel built up of a core and a decorative layer on one or on both sides of the core.

From U.S. Pat. No. 6,185,840 a method is known wherein a radiation-curable layer is applied to a substrate, for example paper, glass, plastics, wood or metal. The layer thus applied is passed through a curing unit, which uses ultraviolet light for the curing step, whilst the space in which the curing step is carried out is flushed with a gas. The method that is known therefrom in fact comprises two steps, viz. a first step, in which the applied layer, which generally is heat-sensitive and has a thickness of 10-50 μm, must be cooled during the UV radiation. The second step can be considered as a drying/curing operation in a specific atmosphere, for example an inert gas, in particular nitrogen or carbon dioxide. The inert atmosphere in particular functions to prevent the chemical reactions being adversely affected, so that a good bond and good surface properties are obtained.

European patent application No. 0 724 914 relates to a method for the continuous painting of moving elements, in particular rod-shaped wooden elements, wherein, after the application of a first layer of paint to the element, the layer of paint thus applied is removed by brushing, after which a second layer of paint is applied, and the drying thereof is carried out by means of ultraviolet radiation.

European patent application No. 1 157 750 relates to a method for coating the internal surface of a polyethylene container with a radiation-curable epoxy-based polymeric composition, using electromagnetic radiation.

U.S. Pat. No. 6,677,045 relates to a multilayer coating comprising a basecoat layer and a topcoat layer, wherein a basecoat layer is applied to a substrate and heated to a temperature of maximally 100° C., after which a topcoat is applied to said basecoat layer, followed by radiation curing. Although the basecoat layer is not fully cured after said thermal treatment, it cannot be considered as a fluid layer.

International application WO 03/064061 relates to a process for the application of a coating to a substrate, wherein the substrate is pre-treated by means of a low-temperature plasma, a corona discharge or a flame, after which a coating is applied to the substrate thus pre-treated, which coating is subsequently dried by means of electromagnetic waves.

U.S. Pat. No. 6,528,126 relates to a process for the application of a multilayer coating to a (possibly precoated) substrate, wherein a coating is applied to the substrate, to which a topcoat is applied, after which at least one of the layers thus applied is alternately irradiated with UV radiation and IR radiation, using a radiation source comprising UV radiation as well as IR radiation, which radiation lasts at least 30 seconds.

The object of the present invention is to apply a thin layer to a surface whilst effecting a good bond of the thin layer to the surface.

Another object of the invention is to apply a thin layer to a surface, wherein the thin layer penetrates the surface by diffusion, in such a manner that the functionality of the thin layer is retained.

Yet another object of the invention is to make it possible to influence the functionality of the thin layer as needed.

The method as referred to in the introductory paragraph is characterized in that the layer is applied as an aerosol, with a layer yet to be cured by radiation being used as the surface.

The use of an aerosol makes it possible to apply very thin layers to the surface, in which connection the aerosol technique must be considered as a flow of droplets in a gas phase, with the diameter of the droplets generally being significantly smaller than 100 μm. Such droplets may also contain one or more solids. It is also possible, however, to dissolve solids in a solvent first and then convert the composition thus obtained into an aerosol. Coatings differing from each other as regards quality and functionality can be obtained by using a special selection of the liquid-gas composition of the aerosol. Thus it is possible in the present invention to adapt the functionality of the layer applied as an aerosol, in which connection in particular a specific degree of gloss, antistatic properties, a high scratch resistance, antibacterial properties and self-cleaning properties must be considered. A certain degree of mixing will take place at the interface of the aerosol layer and the surface. Such mixing is mainly caused by the fact that the surface is still fluid and that curing of said surface must take place yet. Mixing is such that the functionality of the layer applied as an aerosol is retained. In the present invention, the surface and the layer that has been applied thereto as an aerosol are cured in a single radiation step, with no forced drying step or other intermediate processing steps being required.

To effect a good bond between the layer applied as an aerosol and the surface it is desirable to apply for the aerosol to a fluid layer yet to be cured by radiation, in which connection it is in particular desirable to subject the assembly of aerosol and layer yet to be cured by radiation to a follow-up treatment with radiation, in particular electron radiation and/or UV radiation. Thus a good bond between the aerosol layer and the fluid surface is realized. The curing process is carried out in fractions of seconds. Furthermore, there is no need for combinations of radiation sources.

The aerosol formulation, which may in particular be a water-based or a solvent-containing aerosol, consists on the one hand of one or more active components which provide the bond and the compatibility with the surface and on the other hand of components that provide the eventual functionality of the surface of the layer applied as an aerosol. In a special embodiment of the present invention, it is preferable to use components which combine the two properties, for example molecules comprising a group having surface functionality, such as quaternary ammonium salts, and a group that can be cured by radiation, such as acrylate. In a specific embodiment, the aerosol preferably contains only one or more active components, without additional solvents, such as water or organic solvents, being used.

As a result of the use of water and/or solvents in the aerosol formulation it has appeared to be possible to apply a relatively thick layer to the surface, which layer can more or less flow together with the still fluid surface to form a closed film. Part of the water and/or the solvents will evaporate upon transfer of the combination of surface and layer applied as an aerosol thus effected to a radiation unit, viz. a UV unit or an EB (electron beam) unit. Complete evaporation generally takes place as a result of the exothermic reaction heat that is released during the polymerization step in the radiation unit. After evaporation, the final layer thickness of the layer applied as an aerosol is reached.

Using the present method, a layer thickness of 1-200 nm after curing of the layer applied as an aerosol can be realized, with the thickness of the radiation-curable layer of the surface being 4-100 μm.

In a special embodiment, the fluid surface is preferably present on a substrate, in particular a cellulose-containing material impregnated with a curable resin. Impregnated paper, in particular of one or more kraft papers impregnated with a phenol resin, can be mentioned as a suitable substrate.

The aerosol to be used in the present invention preferably contains components to be cured by means of electron radiation and/or UV radiation, and it may be a water-based or a solvent-containing formulation.

In the present invention one or more functional components selected from the group consisting of bactericides, brighteners, scratch resistance enhancers, matting agents, antistatics, surface tension modifiers, algicides, anti-graffiti agents, surface-cleaning agents, pigments, friction-influencing agents and fire retardants, may be added to the aerosol.

The present invention further relates to an assembly comprising a layer present on a surface, which is characterized in that said layer is a layer applied as an aerosol and that the surface is a radiation-cured layer.

The thickness of the layer applied as an aerosol in the present assembly is 1-200 nm after curing, with the thickness of the radiation-cured layer being 4-100 μm.

In a special embodiment, one or more components selected from the group consisting of bactericides, brighteners, scratch resistance enhancers, matting agents, antistatics, surface tension modifiers, algicides, anti-graffiti agents, surface-cleaning agents, pigments, friction-influencing agents and fire retardants is (are) preferably contained in the layer applied as an aerosol.

In a special embodiment of the present assembly, the surface, which is a radiation-cured layer, is present on a substrate, preferably a cellulose-containing material impregnated with a curable resin, in particular an impregnated paper, such as a kraft paper impregnated with a phenol resin, or a number of such kraft paper layers.

The present assembly is in particular suitable for being used in a decorative panel, which decorative panel is built up of a core provided with one or more decorative layers on one or on both sides thereof, wherein the present assembly is used as a decorative layer. The core that is used may in particular be composed of one or more resin-impregnated, cellulose-containing layers.

Using the present method, wherein a so-called aerosol deposition is carried out in combination with a layer yet to be cured by radiation, it is possible to apply a very thin layer to a fluid surface, in particular a previously applied coating, wherein a durable bond between the layer and the surface is effected as a result of the rapid curing that takes place when a radiation-curable crosslinking process is carried out. Using the present method it is in particular possible to adjust the functionality of the layer applied as an aerosol, in particular the upper layer, according to specific objectives.

The present invention will now be explained by means of a number of examples, in which connection it should be noted, however, that the present invention is by no means limited to such special examples.

### EXAMPLES

A coating of a radiation-curable coating consisting of an acrylate groups-containing oligomer (65%) diluted with HDDA to a viscosity of 2000 mPas was applied to PVC in a thickness about 30 μm by means of a film applicator. The same radiation-curable coating was applied to a partially cured coating, which coating was in turn applied to a paper impregnated with a phenol resin.

A water-based formulation was applied as an aerosol to the still fluid acrylate groups-containing coating by means of an airbrush gun. The intention was to obtain a closed film layer. The film layer applied as an aerosol was closed at 1-10 g/m² of wet film. The layer thickness required in order to have water droplets flow together into a closed film appeared to depend on the surface tension of the aqueous formulation. Said surface tension was set by adding a surfactant. An amount of 0.2 wt. % of softanol 70 was added to the water for setting the surface tension.

It was established that the kinetic energy of the droplets to be sprayed must not be too large, because they will interfere with the wet underlying film layer in that case and the droplets are prevented from flowing together if they impact too deep into the wet layer. The impact can be reduced by using small droplets with low impact velocities.

The samples with the still fluid radiation-curable coating with the water-based formulation applied as an aerosol present thereon were transported to an electron beam radiation source, after which the entire system was polymerized, using an acceleration voltage of 150 kV and a surface dosage of 60 kGray.

The water in the water-based formulation largely evaporated during transport to the radiation source and during radiation with electrons.

A properly cured surface film had formed after the radiation step. No harmful effects of the applied water could be observed.

The active components in the water-based formulation are present in a very thin layer on the surface, i.e. a radiation curable-coating, therefore.

Since the active components in the water-based formulation either contain radiation-curable groups or are mixed with radiation-curable components or are readily compatible with the still fluid surface, the active components are irreversibly bound to the radiation-curable coating to which the water-based formulation had been applied.

The following effects were measured:

### Surface Tension of Samples on PVC, Measured by Means of the Ink Technique:

Reference sample

| | |
|---|---|
| 99.8% water, 0.2% softenol 70 | 35 mN/m |

Sample A

| | |
|---|---|
| 95.8% water, 2% Uvecoat 7177, | 52 mN/m |
| 2% 2-acryloyloxy | |
| ethyl trimethyl-ammonium- | |
| chloride, 0.2% softenol 70 | |

### Surface Resistivity, Ohm/Square

Reference sample

| | |
|---|---|
| 99.8% water, 0.2% softenol 70 | >10 E 12.5 Ohm/square |

Sample B

| | |
|---|---|
| 94.8% water, 3% Uvecoat 7177, | 10 E 10 Ohm/square |
| 2% biocoat 220, 0.2% softenol 70 | |

### Cleanability

Reference sample

| | |
|---|---|
| 99.8% water, 0.2% softenol 70 | Adequate and complete removal |
| | of Edding 3000 permanent marker |

Sample C

| | |
|---|---|
| 97.8% water, 2% 2,2,3,3,4,4,4- | Simple and complete removal |
| heptafluorobutylacrylate, | of Edding 3000 permanent marker |
| 0.2% softenol 70 | |

### HPL

Plates having a thickness of 6 mm were pressed from the samples applied to phenol-impregnated paper, using techniques that are known in the HPL industry (EN 438). Upon measurement, these plates appeared to have the following properties:

### Surface Resistivity, Ohm/Square

Reference sample

| | |
|---|---|
| 99.8% water, 0.2% softenol 70 | >10 E 12.5 Ohm/square |

Sample D

| | |
|---|---|
| 97.8% water, 2% 2-acryloyloxy ethyltrimethyl | 10 E 9 Ohm/square |
| ammonium chloride, 0.2% softanol 70 | |

### Graffity Removal: Removal of Edding 3000 Permanent Marker

Reference sample

| | |
|---|---|
| 99.8% water, 0.2% softenol 70 | Adequate and complete cleaning |

Sample C

| | |
|---|---|
| 97.8% water, 2% 2,2,3,3,4,4,4- | Simple and complete removal of |
| heptafluorobutylacrylate, | Edding 3000 permanent marker |
| 0.2% softenol 70 | |

Activity van E. Coli.

The aforesaid reference sample and Sample B were examined for antibacterial properties, using the JIS Z 2801:2000 method. As a pre-treatment, the samples were subjected to a thorough cleaning operation involving rinsing in hot water and ethanol, with the layer applied as an aerosol in Sample B not exhibiting any delamination.

The activity of E. coli amounted to t=0, 1.2·10⁴ for the reference sample, and decreased to a value of 1.1·10⁴ after 1 hour. The values measured for Sample B were 1.2·10⁴ and 2.3·10³, respectively, which latter value shows a distinct antibacterial activity.

From the above measuring data it is apparent that samples A-D can be given specific functionalities, as a result of which the properties of the respective samples A-D are affected in comparison with the reference sample, which does not comprise such components that influence the functionality. The use of the aerosol formulation has furthermore shown that it is possible to apply uniformly distributed thin layers to a surface.

1. A method for functionalizing a layer comprising radiation curable components by depositing a top layer on top of said layer, the method comprising the following steps:
i) the provision of a fluid layer comprising radiation curable components yet to be cured, said layer being present on a substrate,
ii) the application of said top layer on top of said fluid layer comprising radiation curable components by means of an aerosol comprising active components,
iii) the application of radiation in a radiation unit on the assembly obtained after step ii), wherein polymerization of said fluid layer comprising radiation curable components takes place, and as a result of the heat of said radiation and the exothermic reaction that is released during said polymerization evaporation of the liquid components present in said top layer takes place resulting in said active components containing top layer having a thickness of 1-200 nm.

2. (canceled)

3. (canceled)

4. (canceled)

5. (canceled)

6. A method according to claim 1 wherein the thickness of the layer comprising radiation curable components is 4-100 μm.

7. (canceled)

8. The method according to claim 1 wherein said substrate is a cellulose-containing material impregnated with a curable resin.

9. The method according to claim 8 wherein the substrate is an impregnated paper.

10. The method according to claim 8 wherein said substrate comprises a kraft paper impregnated with a phenol resin.

11. The method according to claim 1 wherein the aerosol contains one or more solvents.

12. The method according to claim 11 wherein the aerosol is water-based.

13. The method according to claim 1 wherein the aerosol contains electron radiation and/or UV radiation curable components.

14. The method according to claim 1 wherein the active components present in said aerosol are selected from the group consisting of bactericides, brighteners, scratch resistance enhancers, matting agents, antistatics, surface tension modifiers, algicides, anti-graffiti agents, surface-cleaning agents, pigments, friction-influencing agents and fire retardants.

15. An assembly comprising a layer comprising radiation curable components on a surface wherein on top of that layer is a top layer applied as an aerosol said top layer having a thickness of 1-200 nm.

16. (canceled)

17. The assembly according to claim 15 wherein the thickness of the layer comprising radiation curable components is 4-100 μm.

18. The assembly according to claim 15 wherein one or more components selected from the group consisting of bactericides, brighteners, scratch resistance enhancers, matting agents, antistatics, surface tension modifiers, algicides, anti-graffiti agents, surface-cleaning agents, pigments, friction-influencing agents and fire retardants is contained in the top layer.

19. (canceled)

20. The assembly according to claim 15 wherein said substrate comprises a cellulose-containing material impregnated with a curable resin.

21. A decorative panel of comprising a core and a decorative layer on one or on both sides of the core wherein the decorative layer comprises the assembly according to claim 15.

22. The decorative panel according to claim 21, wherein said core is composed of one or more resin-impregnated, cellulose-containing layers.

23. The method according to claim 1 wherein the aerosol comprises a flow of droplets in a gas phase, with the diameter of the droplets being <100 μm, wherein said droplets contain active components.

24. The method according to claim 1 wherein step iii) is a single radiation step, with no forced drying step or other intermediate processing steps.

25. The method according to claim 1 wherein the active components are molecules comprising a group having surface functionality and a group that can be cured by actinic radiation.

26. The method according to claim 25 wherein the group that can be cured by actinic radiation comprises an acrylate.

27. The assembly according to claim 20 wherein the substrate comprises an impregnated paper.

28. The assembly according to claim 27 wherein the substrate comprises a kraft paper impregnated with a phenol resin.
